(19) United States
(12) Patent Application Publication
(10) Pub. No.: US 2009/0312041 A1
(43) Pub. Date: Dec. 17, 2009

(54) COMMUNICATION TERMINAL AND METHOD FOR SYNCHRONIZING CLOCK

(75) Inventors: MIN-WEI TSENG, Tu-Cheng (TW); GUI-HUA JIN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/482,461

(22) Filed: Jun. 11, 2009

(30) Foreign Application Priority Data
Jun. 12, 2008 (CN) 200810302111.2

(51) Int. Cl. H04W 4/00

(52) U.S. Cl. 455/466

(57) ABSTRACT

A communication terminal having a synchronization command to synchronize a clock of the communication terminal is provided. The communication terminal sends a short message to a service center in response to the synchronization command. The communication terminal receives a status report containing time information. The communication terminal retrieves the time information from the status report, and synchronizes the clock of the communication terminal according to the retrieved time information. Moreover, a method for synchronizing the clock of the communication terminal is provided.

### BACKGROUND

1. Technical Field

The present disclosure relates to communication terminals, and more particularly to a communication terminal and a method for synchronizing a clock.

2. Description of related art

In general, communication terminals such as mobile phones are provided with clock functions. A clock function enables a mobile phone to display the current/present time generated by a time-generating unit of the mobile phone.

However, the time generated by the time-generating unit may deviate from the correct time, for example, due to replacement of the battery or due to the errors in the time-generating unit itself.

Therefore, it is desired to provide a mobile phone and a method for overcoming the described shortcomings and deficiencies.

### BRIEF DESCRIPTION OF THE DRAWINGS

FIG. 1 is a diagram illustrating a front view of exemplary external components of a communication terminal.

FIG. 2 is a diagram illustrating exemplary internal components that may correspond to the communication terminal depicted in FIG. 1.

FIG. 3 is a signal flowchart for retrieving time information using the communication terminal of FIG. 1 in accordance with a first exemplary embodiment.

FIG. 4 is a signal flowchart for retrieving time information using the communication terminal of FIG. 1 in accordance with a second exemplary embodiment.

FIG. 5 is a flowchart of a method for synchronizing the clock of the communication terminal of FIG. 1 in accordance with an exemplary embodiment.

FIG. 6 is a diagram illustrating an example of a display displaying an incorrect time of the communication terminal of FIG. 1 in accordance with an exemplary embodiment.

FIG. 7 is a diagram illustrating an example of the display displaying a correct time of the communication terminal of FIG. 1 in accordance with an exemplary embodiment.

### DETAILED DESCRIPTION

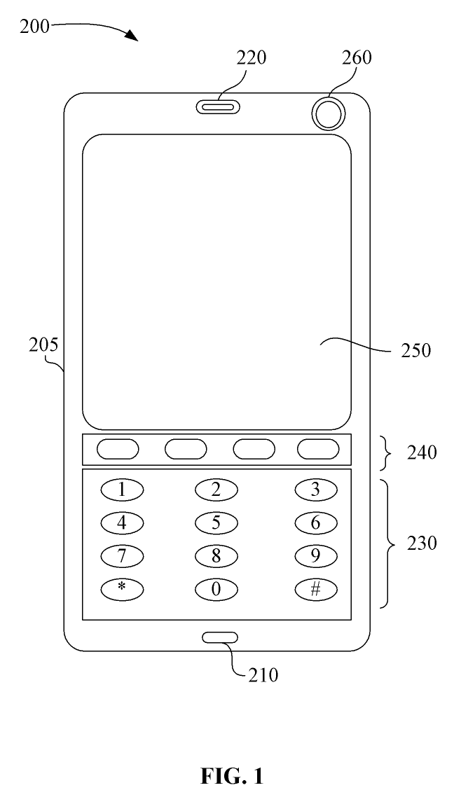

Referring to FIG. 1, a front view of an exemplary communication terminal 200 is illustrated. The communication terminal 200 is intended to be broadly interpreted to include any number of devices capable of establishing communication relationships with other devices. For example, the communication terminal 200 may include a portable device, such as a mobile/cellular phone, a personal digital assistant (PDA), and/or a netbook computer. As used herein, “netbook computer” may refer to a small portable computer designed for wireless communication and access to the Internet. As illustrated, the communication terminal 200 may include a housing 205, a microphone 210, a speaker 220, a keypad 230, function keys 240, a display 250, and a camera 260.

The housing 205 may include a structure to contain components of the communication terminal 200. For example, the housing 205 may be formed from plastic or metal and may support the microphone 210, the speaker 220, the keypad 230, the function keys 240, the display 250, and the camera 260.

The microphone 210 may include any component capable of transducing sound waves to electrical signals. The speaker 220 may include any component capable of transducing electrical signals to sound waves.

The keypad 230 may include any component capable of providing inputs to the communication terminal 200. The keypad 230 may include a standard telephone keypad. The keypad 230 may also include one or more special purpose keys. In one implementation, each key of the keypad 230 may be, for example, a pushbutton, an area of a touch-sensitive screen, etc.

The function keys 240 may include any component capable of providing inputs to the communication terminal 200. The function keys 240 may be operated to perform a variety of operations, such as placing a telephone call, playing various media (e.g., music, videos), and/or sending e-mails. In one implementation, each key of the function keys 240 may be, for example, a pushbutton, an area on a touch-sensitive screen, etc.

The display 250 may include any component capable of providing visual information. For example, in one implementation, the display 250 may be a liquid crystal display (LCD). In another implementation, the display 250 may be any one of other display technologies, such as a plasma display panel (PDP), a field emission display (FED), a light emitting diode (LED) display, etc.

The camera 260 may include any component capable of capturing a still image and/or video images. In one implementation, the communication terminal 200 may include camera software that provides various functions that may be displayed on the display 250 to allow a user to, for example, adjust camera settings.

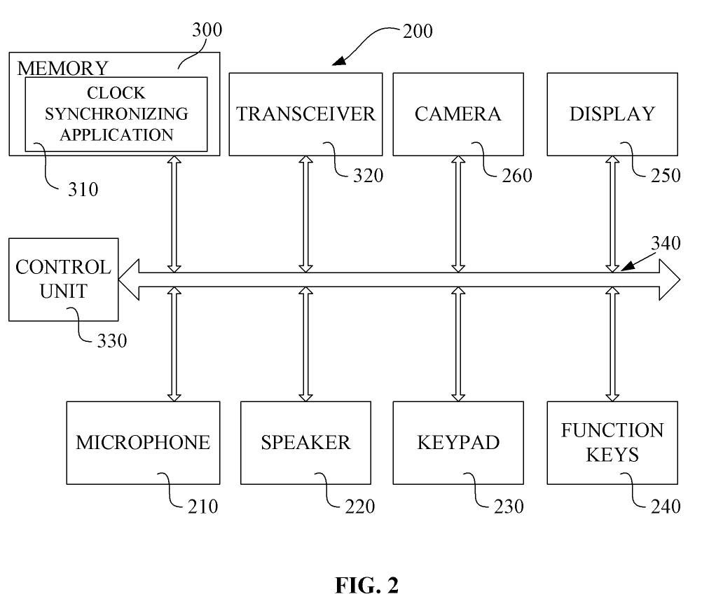

Referring to FIG. 2, a block diagram of the communication terminal 200 depicted in FIG. 1 is illustrated. As illustrated, the communication terminal 200 may include a microphone 210, a speaker 220, a keypad 230, function keys 240, a display 250, a camera 260, a memory 300, a transceiver 320, a control unit 330, and a bus 340. The microphone 210, speaker 220, keypad 230, function keys 240, display 250, and camera 260 may include the features and/or capabilities described above in connection with FIG. 1.

The memory 300 may include any type of storage component that stores data and instructions related to the operation and use of the communication terminal 200. For example, the memory 300 may include a memory component, such as a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. Additionally, the memory 300 may include a storing component, such as a magnetic storage component (e.g., a hard drive), an optical storage component (e.g., a CD drive, a DVD drive, a Blu-ray drive), or another type of computer-readable medium. The memory 300 may also include an external storing component, such as a memory stick, a memory card, and/or a subscriber identity module (SIM) card.

The memory 300 further stores a clock synchronizing application 310. The clock synchronizing application 310 contains software instructions. The software instructions may be read out of the memory 300 and may be interpreted and executed by the control unit 330 to perform processes of synchronizing system clock of the communication terminal 200.

The transceiver 320 may include any component capable of transmitting and receiving data from a network. For example, the transceiver 320 may include a radio circuit that provides wireless communication with the network or another device. As used herein, the “network” may include a wireless network, such as a global system for mobile communications (GSM) network and/or a universal mobile telecommunications system (UMTS) network.

The control unit 330 may include any logic that interprets and executes instructions to control the overall operation of the communication terminal 200. As used herein, the term “logic” may include hardware, software, and/or a combination of hardware and software. The control unit 330 may include, for example, a general-purpose processor, a microprocessor, a data processor, a co-processor, a network processor, an application specific integrated circuit (ASIC), a controller, a programmable logic device, a chipset, a field programmable gate array (FPGA), etc. The control unit 330 may access instructions from the memory 300, from other components of the communication terminal 200, and/or from a source external to the communication terminal 200 (e.g., a network or another device). The control unit 330 may provide for different operational modes associated with the communication terminal 200. Additionally, the control unit 330 may operate in multiple operational modes simultaneously. For example, the control unit 330 may operate in a camera mode, a multimedia player mode, and/or a phone mode.

The bus 340 may include a communication path that allows communication among the components of the communication terminal 200. The bus 340 may include, for example, a system bus, an address bus, a data bus, and/or a control bus. The bus 340 may include bus drivers, bus arbiters, bus interfaces and/or clocks.

Although FIG. 2 illustrates exemplary components, in other implementations, fewer, additional, and/or different internal components than the internal components depicted in FIG. 2 may be employed. For example, the transceiver 320 and/or the control unit 310 may include their own on-board memory 300. Additionally, or alternatively, the communication terminal 200 may not include the microphone 210, the function keys 240, and/or the camera 260.

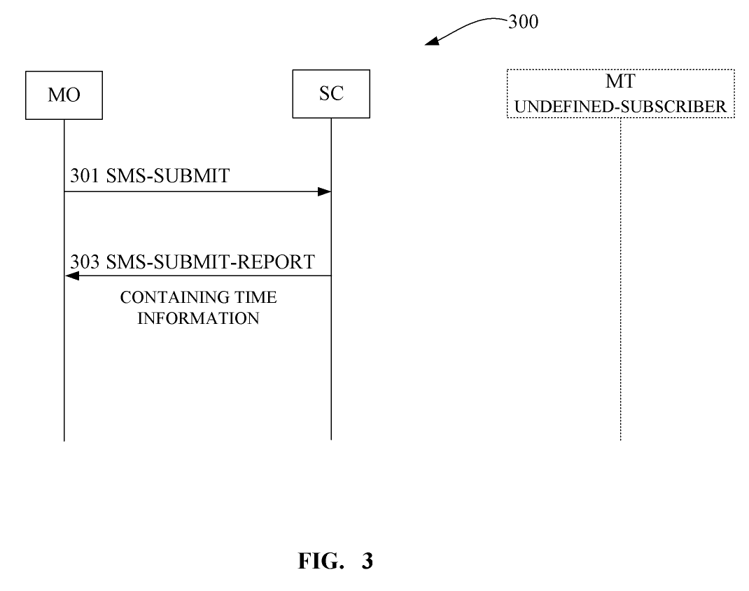

Referring to FIG. 3, a signal flowchart illustrating a method 300 for retrieving time information by sending short messages using the communication terminal 200 in accordance with a first exemplary embodiment is shown. As illustrated, “MO”, a short term for mobile originated, refers to a communication terminal that has the ability to send short messages using the short message services (SMS). “MT”, a short term for mobile terminated, refers to a communication terminal that has the ability to receive short messages. It should be noted that the “MO” may also has the ability to receive short messages, and the “MT” may also has the ability to send short text messages. “SC”, a short term for service center, refers to a terminal or party that is responsible for the relaying and store-and-forwarding of a short message between short message entities, such as MO and MT, and mobile stations. The method 300 includes the following steps.

At step 301, the MO intentionally submits a short message (SMS-SUBMIT) with undefined-subscriber to the SC. As used herein, the “undefined-subscriber” refers to a MT that there is not such a terminal or party. For example, the undefined-subscriber is not recorded in the SC. As such, the SC cannot forward the short message to the undefined-subscriber.

At step 303, the SC sends a status report (SMS-SUBMIT-REPORT) to the MO. The status report includes information of a negative acknowledgement in response to the SMS-SUBMIT. When the SC determines that the short message is sent to an undefined-subscriber, the SC returns the status report with a negative acknowledgement.

Because the status report (SMS-SUBMIT-REPORT) contains a timestamp, the communication terminal 200 retrieves time information from the timestamp of the status report, and synchronizes the clock of the communication terminal 200 accordingly.

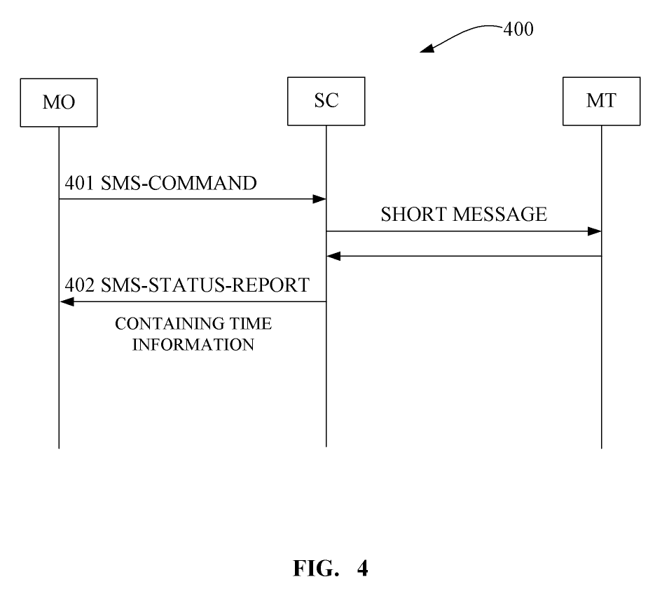

Referring to FIG. 4, a signal flowchart illustrating a method 400 for retrieving time information by sending short messages using the communication terminal 200 in accordance with a second exemplary embodiment is shown. The method 400 includes the following steps.

At step 401, in addition to sending a short message, the MO also sends a request (SMS-COMMAND) to the SC in order to return a status report (SMS-STATUS-REPORT) from the SC.

At step 402, when the short message is successfully delivered to the MT, the SC forwards the status report (SMS-STATUS-REPORT) to the MO.

Because the status report (SMS-STATUS-REPORT) also contains a timestamp, the communication terminal 200 retrieves the time information from the timestamp of the status report, and synchronizes the clock of the communication terminal 200 accordingly.

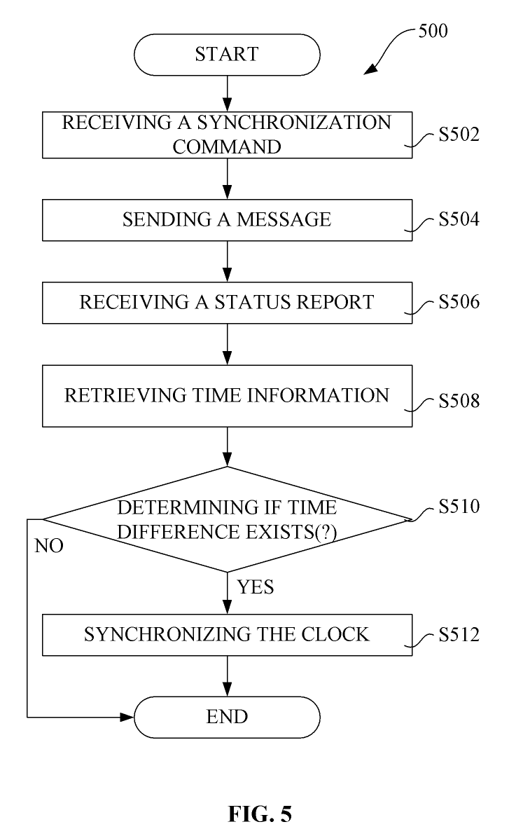

Referring to FIG. 5, a flowchart of a method 500 for synchronizing the clock of the communication terminal 200 is illustrated. The method 500 includes following steps.

At step S502, the communication terminal 200 may receive a synchronization command to synchronize the clock of the communication terminal 200. The synchronization command may be input by pressing a key of the communication terminal 200. In other instances, the communication terminal 200 may automatically synchronize the clock of the communication terminal 200 when the communication terminal 200 boot-ups. Additionally, or alternatively, the communication terminal 200 may include a motion sensor (not shown in figures) which may trigger the communication terminal 200 to synchronize the clock of the communication terminal 200.

At step S504, the communication terminal 200 sends a short message in response to the synchronization command. The communication terminal 200 pre-stores the short message in the memory 300. In one implementation, the short message may be appropriately arranged, such that the short message is intentionally sent to an undefined-subscriber. As used herein, the “undefined-subscriber” refers to a MT that there is no such terminal or party. For example, the undefined-subscriber is not recorded in the SC. In another implementation, the short message is normally sent to a MT, which is recorded in the SC.

At step S506, the communication terminal 200 receives a status report from the SC. The status report contains a timestamp with time information.

At step S508, the communication terminal 200 retrieves the time information from the timestamp of the status report.

At step S510, the communication terminal 200 determines if the time of the communication terminal 200 is deviated from the retrieved time information from the timestamp of the status report. If yes, the procedure goes to step S512. If no, the procedure goes to end.

At step S512, the communication terminal 200 synchronizes the clock of the communication terminal 200 according to the retrieved time information from the timestamp of the status report.

It should be noted that the various steps in the method 500 illustrated in FIG. 5 may be performed in the order presented, or may be performed in a different order. Furthermore, in some embodiments, some steps can be canceled from the method 500.

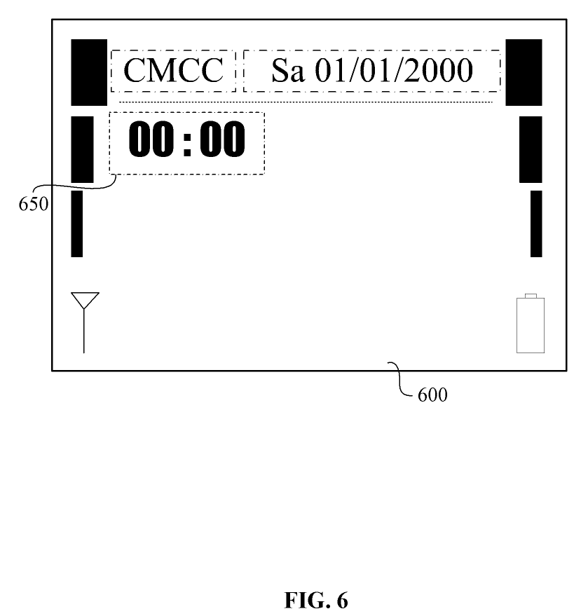

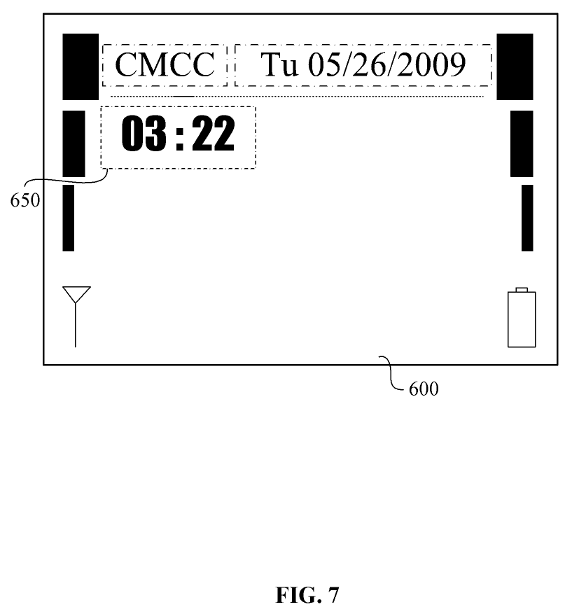

Referring to FIG. 6 and FIG. 7, a diagram illustrating an example of a display 600 of the communication terminal 200 of FIG. 1 is shown. As illustrated in FIG. 6, the display 600 displays a default system time 00:00 (indicated by 650) due to a removal and/or an attachment of a battery of the communication terminal 200. After receiving an adjust command, the communication terminal 200 invokes/implements the clock synchronizing application 310 stored in the memory 300 to automatically adjust the time of the communication terminal 200. As illustrated in FIG. 7, the time of the communication terminal 200 is adjusted to 03:22. As such, it does not need a user to adjust the time of the communication terminal 200 manually.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A communication terminal, comprising:
a memory;
a control unit; and
a clock synchronizing application stored in the memory and configured for execution by the control unit, the clock synchronizing application comprising instructions to:
receive a synchronization command to synchronize a clock of the communication terminal;
send a short message in response to the synchronization command;
receive a status report in association with the short message;
retrieve a time information from the status report; and
synchronize the clock of the communication terminal according to the retrieved time information.

2. The communication terminal according to claim 1, wherein the instruction of to send a short message comprises: intentionally send a short message with an undefined-subscriber to a service center.

3. The communication terminal according to claim 2, wherein the instruction of to receive a status report in association with the short message comprises: receive a SMS-SUBMIT-REPORT from the service center, wherein the SMS-SUBMIT-REPORT comprises information indicating that the short message is sent to the undefined-subscriber; and the SMS-SUBMIT-REPORT comprises a timestamp with time information.

4. The communication terminal according to claim 1, wherein the clock synchronizing application further comprises instructions to: send a request command in order to receive a SMS-STATUS-REPORT from a service center.

5. The communication terminal according to claim 4, wherein the instruction of to receive a status report in association with the short message comprises: receive the SMS-STATUS-REPORT from the service center, wherein the SMS-SUBMIT-REPORT comprises information indicating that the short message is successfully sent to a receiver; and the SMS-SUBMIT-REPORT comprises a timestamp with time information.

6. The communication terminal according to claim 1, wherein the clock synchronizing application further comprises instructions to: determine if the time of the communication terminal is deviated from the retrieved time information from the status report; and synchronize the clock of the communication terminal upon determination that the time of the communication terminal is deviated from the retrieved time information from the status report.

7. A method for adjusting a time of a communication terminal, the method comprising:
receiving a synchronization command to synchronize a clock of the communication terminal;
sending a short message in response to the synchronization command;
receiving a status report in association with the short message;
retrieving a time information from the status report; and
synchronizing the clock of the communication terminal according to the retrieved time information.

8. The method according to claim 7, wherein the action of sending a short message comprises: intentionally sending a short message with an undefined-subscriber to a service center.

9. The method according to claim 8, wherein the action of receiving a status report in association with the short message comprises: receiving a failure SMS-SUBMIT-REPORT from the service center, wherein the SMS-SUBMIT-REPORT comprises information indicating that the short message is sent to the undefined-subscriber; and the SMS-SUBMIT-REPORT comprises a timestamp with time information.

10. The method according to claim 7, further comprising:
sending a request command in order to receive a SMS-STATUS-REPORT from a service center.

11. The method according to claim 10, wherein the action of receiving a status report in association with the short message comprises: receiving the SMS-STATUS-REPORT from the service center, wherein the SMS-SUBMIT-REPORT comprises information indicating that the short message is successfully sent to a receiver; and the SMS-SUBMIT-REPORT comprises a timestamp with time information.

12. The method according to claim 11, further comprising:
determining if the time of the communication terminal is deviated from the retrieved time information from the status report; and
synchronizing the clock of the communication terminal upon determination that the time of the communication terminal is deviated from the retrieved time information from the status report.

13. A method, comprising:
receiving a synchronization command to synchronize a clock of a communication terminal;
sending a short message in response to the synchronization command;
receiving a status report in association with the short message;
retrieving a time information from the status report;
determining if the clock of the communication terminal is deviated from the retrieved time information; and
synchronizing the clock of the communication terminal according to the retrieved time information upon determination that the clock of the communication terminal is deviated from the retrieved time information.

14. The method according to claim 13, wherein the action of sending a short message comprises: intentionally sending a short message with an undefined-subscriber to a service center.

15. The method according to claim 14, wherein the action of receiving a status report in association with the short message comprises: receiving a failure SMS-SUBMIT-REPORT from the service center, wherein the SMS-SUBMIT-REPORT comprises information indicating that the short message is sent to the undefined-subscriber; and the SMS-SUBMIT-REPORT comprises a timestamp with time information.

16. The method according to claim 13, further comprising:
sending a request command in order to receive a SMS-STATUS-REPORT from a service center.

17. The method according to claim 16, wherein the action of receiving a status report in association with the short message comprises: receiving the SMS-STATUS-REPORT from the service center, wherein the SMS-SUBMIT-REPORT comprises information indicating that the short message is successfully sent to a receiver; and the SMS-SUBMIT-REPORT comprises a timestamp with time information.
